(19) United States
(12) Patent Application Publication
(10) Pub. No.: US 2011/0109185 A1
(43) Pub. Date: May 12, 2011

(54) HIGH EFFICIENCY MAGNETIC CORE ELECTRICAL MACHINE

(75) Inventors: John T. Sullivan, Marriottsville, MD (US); Steve Parks, Derwood, MD (US)

(73) Assignee: John T. Sullivan, Marriottsville, MD (US)

(21) Appl. No.: 12/614,988

(22) Filed: Nov. 9, 2009

(51) Int. Cl. H02K 21/24; H02K 23/44; H02P 6/08; H02K 9/22; H02K 16/00

(52) U.S. Cl. 310/156.35; 310/156.36; 310/209; 318/721; 310/52; 310/114

(57) ABSTRACT

A magnetic core electrical machine includes a plurality of “U”-shaped stator yokes arranged circumferentially with respect to a rotor and either staggered to form a continuous flux return path or displaced relative to permanent magnets of the rotor in order to reduce cogging. Various mechanisms and/or circuits are provided to limit an output of the electrical machine at high speeds, and boost the voltage output at low speeds.

### BACKGROUND OF THE INVENTION

1. Field of the Invention

This invention relates to electrical machines of the type having a magnetic core. The electrical machines of the invention may be used as motors or generators, and may include any of the following features:
a plurality of “U”-shaped stator yokes arranged circumferentially with respect to the rotor and staggered on opposite sides of the rotor to form a continuous flux return path;
a plurality of “U”-shaped stator yokes oriented radially with respect to the rotor, the poles of the stator yokes being shifted relative to the rotor magnets to provide an asymmetric pole arrangement that minimizes “cogging” due to attraction between the magnetic stator core and permanent magnets in the rotor of the electrical machine, the rotor magnets and yokes optionally having an odd/even numerical relationship;
a plurality of “C” shaped stator yokes arranged around a periphery of the rotor, in which the rotor magnets and yokes have an odd/even numerical relationship to minimize cogging;
mechanisms for reducing the torque and/or voltage output of the electrical machine when operated as a generator at high speeds so as to avoid excessive output that might damage the load, the mechanisms including a plate or plates that reduce the amount of magnetic flux between the rotor magnets and stator poles; an actuator for increasing a distance between the rotor magnets and stator poles; and/or a voltage reduction circuit for reducing a voltage and impedance of the electrical machine by switching from a series to a parallel-connection between the stator coils in response to detection of the rotor speed (or other operating parameter indicative of a potential over-voltage);
a boost circuit provided to increase the voltage output of the electrical machine by causing the flux in individual stator yoke assemblies to briefly increase, thereby inducing an additional “boost” voltage in the outputs of the individual coils when the electrical machine is operated as a generator at low speeds.
   The electrical machine of the invention is especially suitable for use in wind turbine applications, but are not limited thereto.

2. Description of Related Art

The need for high efficiency electrical machines has become increasingly critical as fossil fuel supplies become depleted and/or more expensive to extract. However, motors and generators that utilize electro-magnetic induction continue to be less cost effective in many applications than fossil fuel based motors and generators, particularly for transportation and alternative power generation. At present, improvements are urgently needed in the areas of wind turbines, solar-heated steam turbines, wave-powered generators, and other generators responsive to intermittent motion or vibrations, as well as in the field of electric motors used for transportation and other applications where the weight and efficiency of the motor is critical. Electrical machines used as motors in personal vehicles, for example, must by light weight and highly efficient to extend battery range between charges. Electrical machines used as generators, on the other hand, must be capable of operating efficiently at a wide range of speeds, often in harsh environments. For example, wind generators much be capable of operating efficiently in low winds while withstanding, or even operating in, high wind conditions that might result in excessive output necessitating braking, shut-down, or disconnection of the turbine. Similarly, solar-heated steam-driven turbines must be capable of operating on both cloudy days and under conditions of direct sunlight.

In order to increase efficiency of an electric generator or motor, it is well known to provide flux return paths for fluxes induced in magnetic poles. This type of electric machine is known as a magnetic core machine, with the core being made iron or an iron alloy having high magnetic permeability that conducts magnetic flux between the poles. Efficiency is increased because the flux return paths concentrate magnetic fields and prevent energy losses resulting from the normal magnetic field distribution in air. As a result, magnetic core electrical machines are relatively low in cost and less bulky relative to coreless machines, which require an increased magnet size and number of coils to compensate for lower efficiency.

However, current magnetic core electrical machine designs are unsuitable for many applications because of performance problems resulting from the so-called “cogging” force that opposes movement of the rotor in both generators and motors. The “cogging” effect is particularly pronounced at start-up and low RPMs, acting as a parking brake to prevent rotation of the rotor, although it is present to some degree at all speeds in all types of magnetic core motors and generators. On the other hand, at high speeds, an entirely different problem arises, namely the problem of handling excess output. For example, a wind generator can be subject to wind speeds ranging from less than one mile per hour to 60 or more miles per hour, with the energy input increasing at approximately the square of the wind speed. At high speeds, the output of the generator will be too high for a conventional generator set-up to handle, necessitating braking of the rotor, or disconnection of the turbine from the load.

The problem of cogging has been previously addressed in U.S. Pat. No. 4,424,463, which discloses a motor including a disc-shaped stator having a plurality of radially-outward facing teeth distributed around the circumference of the stator, and a plurality of inwardly extending permanent magnet poles arranged on a circular rotor to face the teeth of the stator. In a first embodiment, the rotor includes 48 poles equally distributed around the rotor and spaced a distance w from each other, while the teeth of the stator are arranged in four groups of five having equal spacing w between the teeth within the groups, but unequal spacing between the groups so that only one group can face corresponding teeth at a time. In other embodiments, the poles and teeth extend from the disks in an axial direction, and the number of poles and teeth are equal, but the teeth are still divided into four groups with circumferential displacement of the groups. As a result of the shifted groups of teeth, even when one group is aligned with corresponding poles, at least one other group will lead the corresponding poles in its section while another group will lag the corresponding poles, with the result that the net force “cogging force” substantially cancels out for the rotor as a whole, thereby reducing cogging.

While the elimination of cogging increases the efficiency and provides smoother and quieter operation for the disc motor disclosed in U.S. Pat. No. 4,424,463, such disc motors still have the disadvantages of being relatively heavy and difficult to manufacture, particularly with respect to larger electrical machines such as might be found in a wind turbine generator arrangement. In such applications, it is preferable to replace the iron disks with discrete magnetic cores for the poles, thereby minimizing the amount of iron required of the stator. U.S. Pat. No. 6,552,460 shows one such arrangement, in which the stator includes toroidal magnetic members having ends that face opposite sides of the rotor. In order to provide smoother operation, the ratio of the number of stator poles and magnetic poles in the disc-shaped rotor of U.S. Pat. No. 6,552,460 is arranged to be 4:6.

The present invention provides alternative stator designs relative to the stators disclosed in the above-cited patents. Rather than a monolithic stator as in U.S. Pat. No. 4,424,463 or C-shaped cores that extend on both sides of the rotor as in U.S. Pat. No. 6,552,460, the present invention provides simple “U”-shaped yokes that are arranged on opposite sides of the rotor in unique staggered or radially-aligned constructions that are light in weight and simple to assemble, and yet that can be arranged to reduce or eliminate cogging while still achieving high efficiency. While “U”-shaped yokes are known for example from U.S. Pat. No. 5,179,307, the present invention combines them with high efficiency and anti-cogging stator designs to provide enhanced utility for many applications. Further, the stator constructions of the preferred embodiments can easily be adapted to include mechanisms for controlling the torque or electrical output of the electrical machine, by inserting magnetic flux reducing plates between the rotor and stator and/or by moving the stator towards and away from the rotor, with additional output control being optionally provided by unique voltage reduction circuitry at high speeds and boost circuitry at low speeds.

### SUMMARY OF THE INVENTION

It is accordingly an objective of the invention to provide electrical machines having high efficiency at both high and low speeds, the ability to operate under a wide range of conditions, and yet that are reliable, simple to assemble, and relatively light in weight.

According to a first preferred embodiment of the invention, an electrical machine includes plurality of “U”-shaped stator yokes arranged circumferentially with respect to the rotor and staggered on opposite sides of the rotor to form a continuous flux return path.

According to another aspect of the invention, an electrical machine includes a plurality of “U”-shaped stator yokes oriented radially with respect to the rotor, the poles of the stator yokes being shifted relative to the rotor magnets to provide an asymmetric pole arrangement that minimizes “cogging” due to attraction between the magnetic stator core and permanent magnets in the rotor of the electrical machine. In an especially advantageous implementation of this embodiment, the poles and permanent magnets are arranged in an odd/even numerical relationship.

According to a yet another aspect of the invention, an electrical machine includes a plurality of “C”-shaped stator yokes arranged around a periphery of the rotor in a manner similar to that disclosed in U.S. Pat. No. 6,552,460, but in which the pole and permanent magnets are arranged in an odd/even numerical relationship.

According to another aspect of the invention, mechanisms are provided to reduce the torque and/or voltage output of the electrical machine when operated as a generator at high speeds so as to avoid excessive output that might damage the load. The mechanisms may includes a plate or plates that reduce the amount of magnetic flux between the rotor magnets and stator poles, an actuator for increasing a distance between the rotor magnets and stator poles, and/or a voltage reduction circuit for reducing a voltage output of the electrical machine by switching from series to parallel coil connections, and thereby reducing the output voltage and impedance, in response to detected rotor speed.

Finally, according to yet another aspect of the invention, a boost circuit is provided to increase the voltage output of the electrical machine when the electrical machine is operated as a generator at low speeds by utilizing the magnetic properties of the stator yokes to briefly increase or decrease magnetic fluxes in the yokes and thereby cause induced voltages in the coils that add to the voltage output of the electrical machine.

### BRIEF DESCRIPTION OF THE DRAWINGS

FIG. 1 is an isometric view showing electro-magnetic components of an electrical machine constructed in accordance with the principles of a first preferred embodiment of the invention.

FIG. 2 is a plan view of the electro-magnetic components illustrated in FIG. 1.

FIG. 3 is a schematic view of the “series” arrangement of the components illustrated in FIGS. 1 and 2.

FIG. 4 is an isometric view showing electro-magnetic components an electrical machine constructed in accordance with the principles of a second preferred embodiment of the invention.

FIG. 5 is a plan view of the electro-magnetic components illustrated in FIG. 2.

FIG. 6 is an isometric view showing components of an electrical machine constructed in accordance with the principles of a third preferred embodiment of the invention.

FIGS. 7 and 8 are plan view of a torque controller for the electrical machine illustrated in FIG. 6.

FIG. 9 is a side view of an electrical machine constructed in accordance with the principles of a fourth preferred embodiment of the invention.

FIG. 10 is a side view showing the electrical machine of FIG. 9, after activation of a torque controller.

FIG. 11 is an isometric view of an electrical machine constructed in accordance with the principles of a fifth preferred embodiment of the invention.

FIG. 12 is a schematic illustration of a conventional electrical machine.

FIG. 13 is a schematic illustration of the manner in which the conventional electrical machine may be modified to eliminate cogging according to the principles of a sixth preferred embodiment of the invention.

FIG. 14 shows a variation of the cogging elimination arrangement of FIG. 13.

FIG. 15 is an isometric view of the electrical machine of FIG. 13.

FIGS. 16 and 17 are schematic illustrations of a variation of the rotor and stator of FIGS. 13-15 adapted for three phase operation.

FIG. 18 is an isometric view of an electrical machine constructed in accordance with the principles of a seventh preferred embodiment of the invention.

FIG. 19 is a schematic illustration showing the odd/even numerical relationship between poles and magnets in the embodiment of FIG. 18.

FIG. 20 is a schematic circuit diagram of a preferred voltage limiting circuit for use in connection with an electrical machine.

FIG. 21 is a schematic circuit diagram of a preferred boost circuit for use in connection with an electrical machine.

### DETAILED DESCRIPTION OF THE PREFERRED EMBODIMENTS

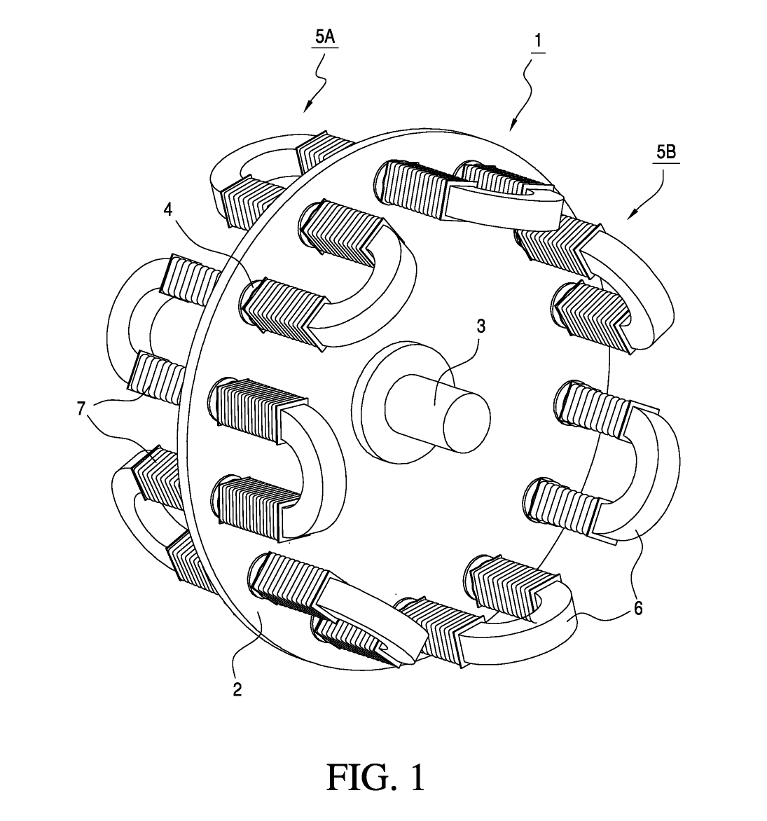

As illustrated in FIGS. 1-3, an electrical machine constructed in accordance with the principles of a preferred embodiment of the invention includes a rotor 1 made up of a non-magnetic plate 2 connected to a shaft 3 and having a plurality of permanent magnets 4 embedded or mounted therein, and a stator 5a,5b including coils 7 and a plurality of generally “U”-shaped high permeability cores or yokes 6 made, for example, of stacked silicon laminations or the like. The permanent magnets 4 and yokes 6 are arranged in series such that each yoke faces like poles of two different yokes on an opposite side of the rotor, thereby providing a continuous magnetic circuit that extends 360° around the circumference of the stator, as best seen in FIG. 3. In particular, as illustrated in FIG. 3, the yokes are staggered such that a first pole 101 of a first yoke 100 on a first side of said rotor faces a first pole 111 of a second yoke 110 on a second side of said rotor, a second pole 102 of said first yoke 100 faces a first pole 121 of a third yoke 120 on the second side of said rotor, the third yoke 120 being different from the second yoke 110, a first pole 131 of a fourth yoke 130 on the first side of said rotor faces the second pole 122 of the third yoke, and so forth for respective poles around the circumference of the rotor, with the permanent magnets 4 being arranged to pass between the facing poles.

If operated the electrical machine of FIGS. 1-3 is operated as a motor, the coils 7 may be energized in conventional fashion by switching polarity as the permanent magnets move from arm of a yoke to the next arm of the yoke or to an adjacent yoke so as to maintain a mutual repulsion between the permanent magnets 4 and poles 8 at ends of the yoke, but instead of providing discrete flux return paths through facing pairs of individual yokes as in the electrical machine of, for example, U.S. Pat. No. 6,552,460 cited above, the flux return paths alternate on opposite sides of the rotor to form a staggered arrangement.

If operated as a generator, rotation of the rotor 1 as a result of an external agent such as wind will induce magnetic fluxes in the yokes as the permanent magnets move past the ends of the yokes, which in turn will induce currents in the coils.

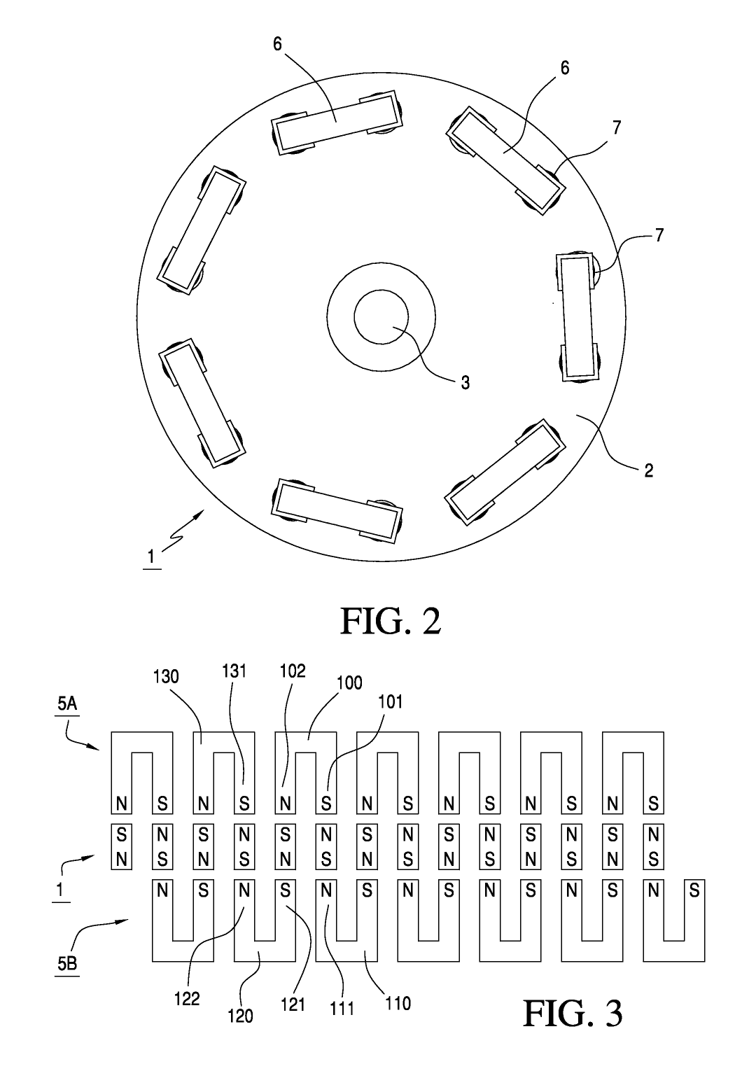

It will be appreciated by those skilled in the art that the yokes illustrated in FIGS. 1 and 2 need not have the illustrated “horseshoe” shapes, but instead may have a less round shape (for example, three perpendicular legs forming three sides of a square or rectangle as in the schematic of FIG. 3), a semi-circular shape, or any other shape in which two ends of the yoke are spaced apart by a distance corresponding to the distance between adjacent permanent magnets 4 of the rotor so as to repel the permanent magnets and cause rotation of the rotor when coils 7 are energized. Thus, the term “U”-shaped is intended to cover any shape in which two legs having poles at distal ends of the legs are connected by a transverse member, including a “␣”-shape, whether or not the transverse member is arc-shaped or generally linear.

In addition, the configuration of the coils and of the rotor may be varied without departing from the scope of the invention, so long as the rotor supports a plurality of permanent magnets spaced around the rotor to face corresponding poles as the rotor rotates, the coils are capable of energizing the yokes to enable such rotation, and/or the coils are capable of being energized by magnetic flux in the yokes upon rotation of the rotor 1 by an outside force. The coils may be connected in a single or multiple phases, and in series, parallel, or any other known winding arrangement.

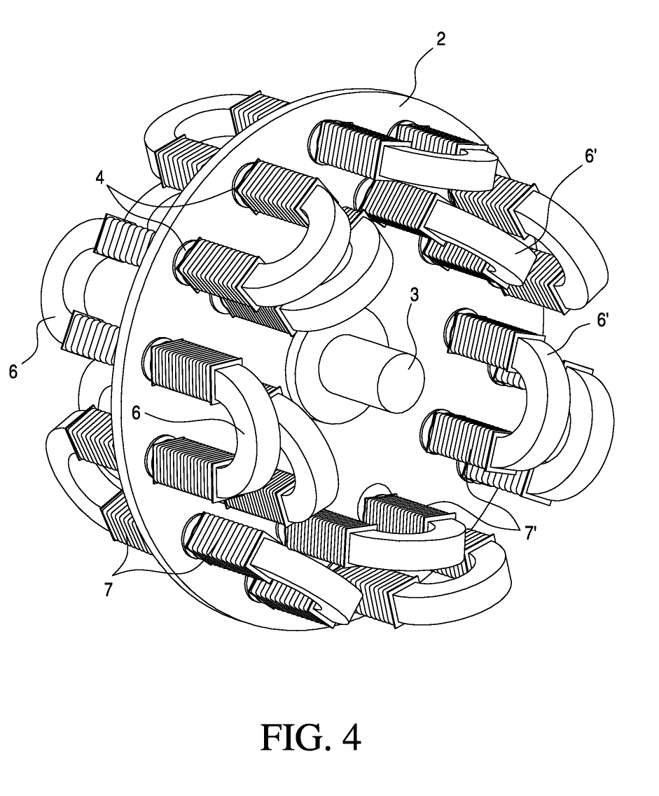

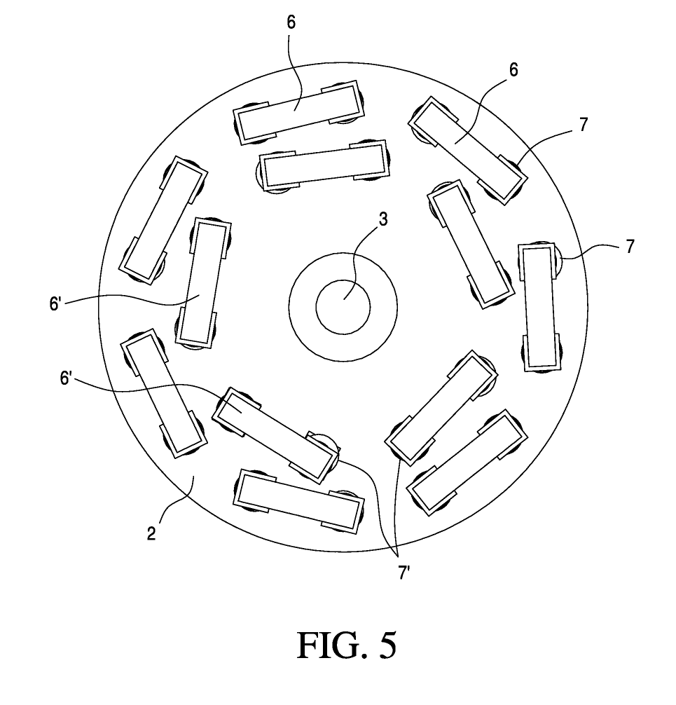

FIGS. 4 and 5 show a modification of the arrangement of FIGS. 1-3, in which a second set of yokes 6′, coils 7′, and permanent rotor magnets 4′ is arranged in a second circle concentric with the first circle formed by yokes 6 and rotor magnets 4. The addition of the second set of yokes, coils, and permanent magnets enables an increase in motor torque or generator output within the same spatial dimensions. Those skilled in the art will appreciate that this embodiment may be varied in the same manner as discussed above in connection with the embodiment of FIGS. 1-3, and further that additional sets of yokes, coils, and magnets may be added in concentric circles within the circle formed by yokes 6′. While the yokes 6′ are illustrated as being angularly shifted or staggered with respect to the yokes 6 such that a number of the yokes 6′ is less than the number of yokes 6 and or to be equal in number, it is also possible to arrange yokes 6′ to be at the same angular positions as yokes 6.

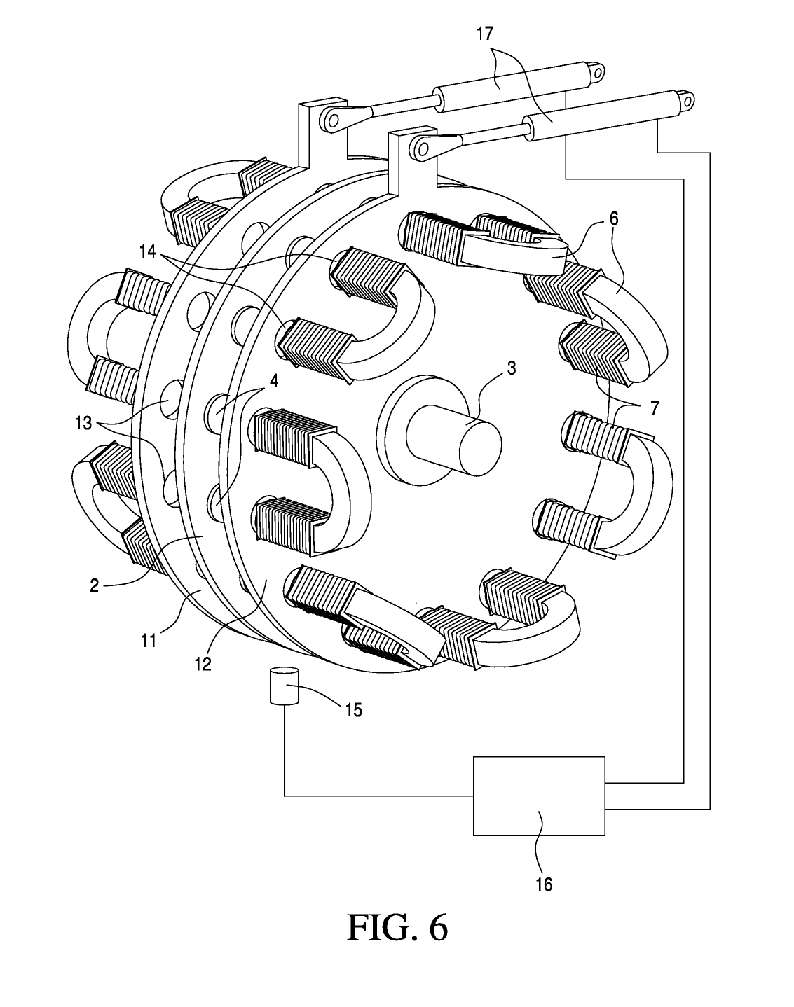

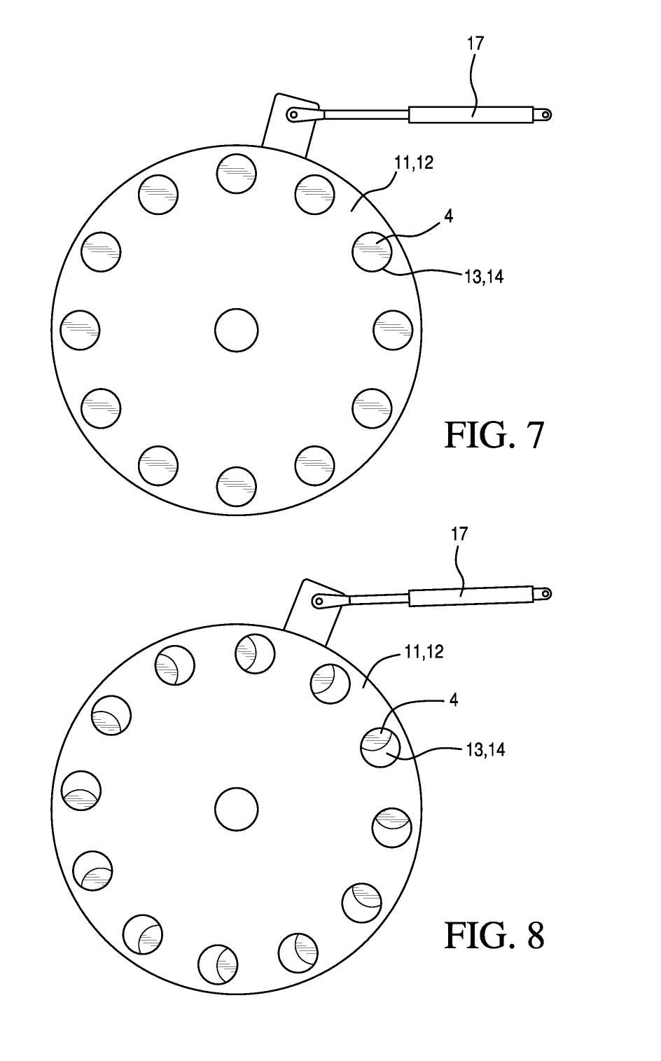

FIGS. 6-8 show an electrical machine of a third preferred embodiment of the invention, in which a torque or output controller 10 is added to the electro-magnetic components illustrated in FIGS. 1-3. The torque or output controller 10 includes two rotatable shield or “output control” plates 11,12 made of a non-magnetic or magnetic shielding material and having a plurality of openings 13,14 arranged circumferentially around a periphery of the plates at positions corresponding to the positions of the poles 8 at the ends of yokes 6 so that when plates 11 and 12 are rotated to a first position, shown in FIG. 7, the openings 13,14 will align with poles 8 on opposite sides of the rotor, and such that as the plates are rotated to a second position, the openings move with respect to the poles such that the size of opening between the poles and the rotor decreases, as indicated in FIG. 8, until the poles 8 are complete separated from the rotor, thus controllably decreasing the amount of magnetic flux that passes between the poles 8 and permanent magnets 4. As the flux between the poles and magnets decreases, so does the torque applied to the rotor in case of a motor or the voltage output by the coils 7 in case of a generator.

As illustrated in FIG. 6, a rotor speed sensor 15 supplies a signal indicative of the rotor speed to a circuit or processor 16, which in turn controls actuators 17 for moving then plates 11,12 between the first and second positions, either individually or together, in order to control the torque or electrical output of the electrical machine. Control of the electrical output is especially useful in case of generator operation in case the rotor is subject to excessive external force, such as might be the case for a wind turbine subject to occasional high winds or storms, with the circuit 16 being arranged to reduce or shut off the electrical output when the rotor reaches an excessive speed. In the case of a motor, the torque controller may as is well known include inputs other than a speed sensor, such as sensor that directly senses output torque, load slippage, and so forth. Those skilled in the art will appreciate that the speed sensor may be replaced, in case of a generator, by circuitry that detects the output of the generator and decreases the output when it is detected to be excessive. As a result, the invention is intended to cover sensor means including not only the illustrated speed sensor, but also any other sensor for detecting any operating parameter of the electrical machine that affects its output, whether the output is in the form of torque or electric power, the sensor means being arranged to output a sensor signal indicative of the detected operating parameter so as to increase the torque or electric power output of the electrical machine in response to the sensor signal.

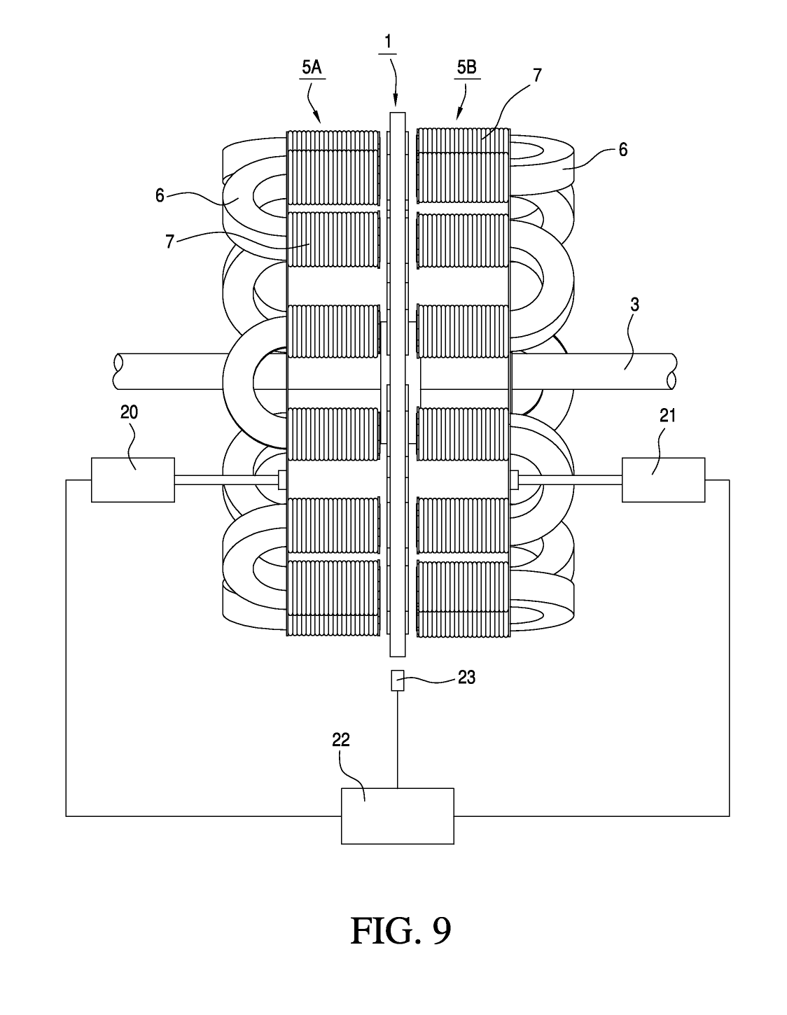

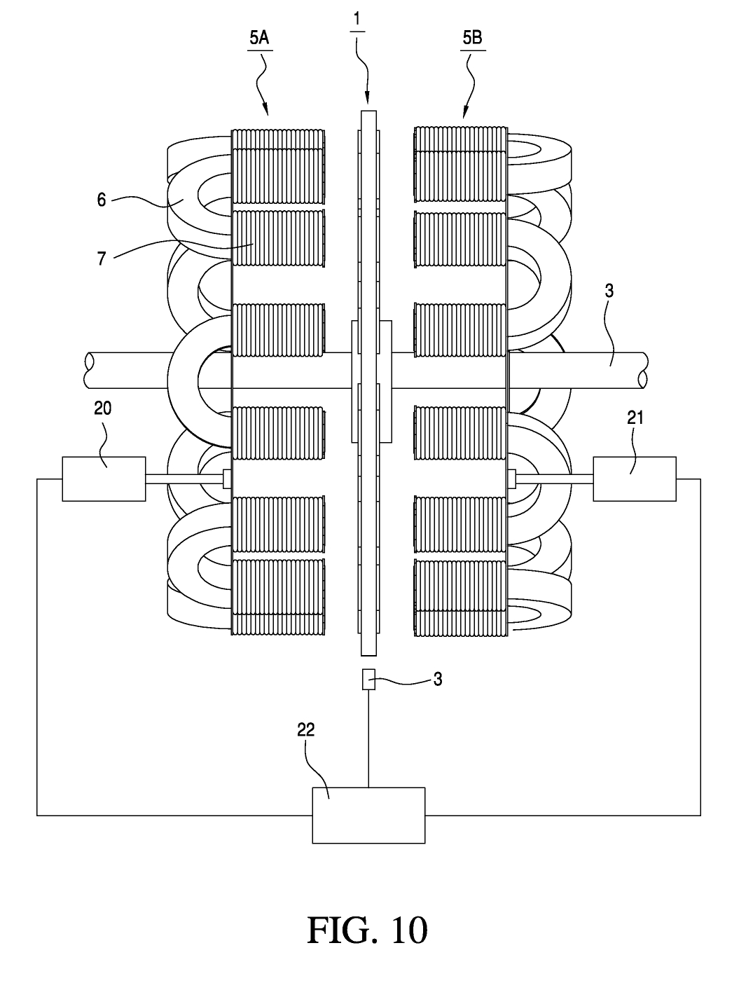

The fourth preferred embodiment of the invention illustrated in FIGS. 9 and 10 represents a variation of the embodiment illustrated in FIGS. 6-8, in which the rotatable flux blocking plates 11,12 are replaced by an arrangement in which stators 5a and 5b are moved toward and away from rotor 1 by actuators 20,21, under control of circuit or processor 22. As in the embodiment of FIGS. 6-8, movement of the stators may be responsive to the output of a speed sensor 23, particularly when the electrical machine is operated as a generator subject to conditions that might cause overvoltages. FIG. 9 shows the stators 5a and 5b in a first position adjacent the rotor 1 for maximum torque or voltage output, while FIG. 10 shows the stators 5a do 5b moved away from the rotor 1 to obtain a lower torque or voltage output.

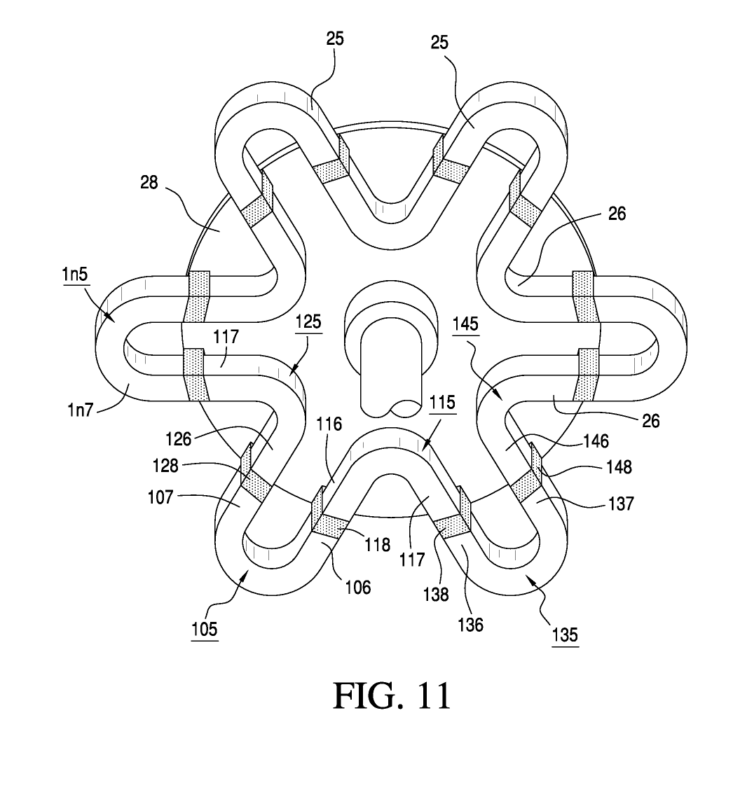

FIG. 11 shows a fifth preferred embodiment of the invention, in which the stator is arranged to include “U”-shaped yokes 25,26 situated on one side of the rotor 28, with permanent magnets (not shown) also being arranged on one side of the rotor to pass between the respective yokes 25,26 and form a series path for the flux, the magnets extending in a circle around the circumference of the rotor. In this embodiment, coils are omitted, but they may be arranged in a manner similar to that illustrated in FIG. 1.

Unlike the embodiment of FIG. 1, in which the principal planes of the yokes are parallel with each other and perpendicular to the rotor, the principal planes of the yokes 25,26 of the embodiment of FIG. 11 are coplanar with each other and parallel with the non-magnetic plate of said rotor 28, such that a first pole 106 of a first yoke 105 faces a first pole 116 of a second yoke 115 with a gap 118 therebetween; a second pole 107 of the first yoke 105 faces a first pole 126 of a third yoke 125 different from the second yoke 115 with a gap 128 therebetween; a second pole 117 of the second yoke 115 faces a first pole 136 of a fourth yoke 135 with a gap 138 therebetween; and a second pole 137 of the fourth yoke 135 faces a first pole 146 of a fifth yoke 145 with a gap 148 therebetween, and so forth such that the yokes thereby form a continuous magnetic flux path extending in a circle with a second pole 117 of the second yoke 115 faces a second pole 1n7 of an nth yoke 1n5, where n is a total number of the yokes and the gaps are aligned with the permanent magnets of the rotor 28.

As illustrated, the gaps are filled with a non-magnetic material though those skilled in the art will appreciate that air gaps may also be used. In addition, as with the embodiment of FIG. 1, those skilled in the art will appreciate that the term “U-shaped” is intended to encompass an shape that includes two generally parallel legs connected by a generally transverse section that may be linear or arc-shaped, and that the yokes may be made of any high permeability material, such as stacked silicon laminations or the like.

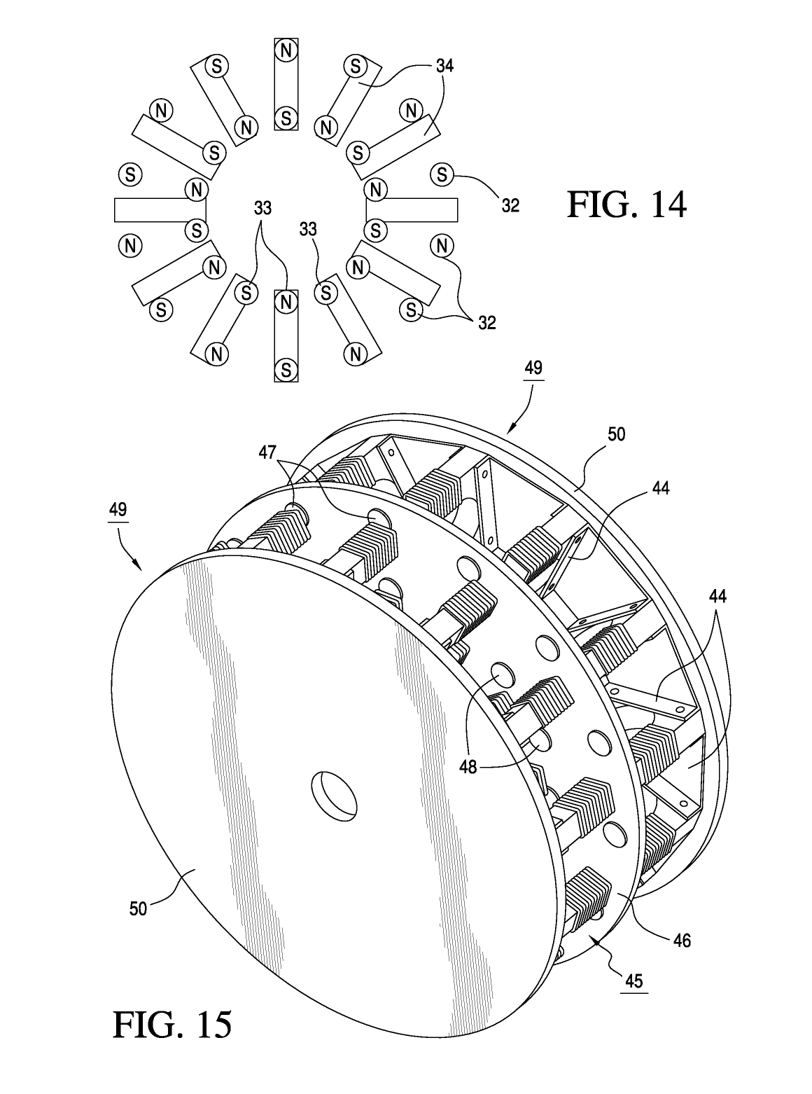

FIGS. 13 and 14 are schematic illustrations of an arrangement for reducing the cogging effect resulting from interaction between the stator poles and the permanent rotor magnets according to a sixth preferred embodiment of the invention. This embodiment again includes a disc-shaped rotor (not shown in FIGS. 13 and 14), but the rotor includes at least two sets of permanent magnets 32,33 arranged in concentric circles, the two sets of permanent magnets 32,33 each extending around a circumference of said rotor with the second set being radially aligned with the first set and including a same number of magnets as the first set. In addition, the electrical machine of this embodiment includes a stator having a plurality of “U” shaped yokes 34, ends of the yokes forming poles 35 that face the rotor, the term “U”-shaped referring to a shape including parallel legs having distal ends that terminate in poles and a connecting section that may be linear or rounded.

Unlike the first embodiment in which the yokes are oriented tangentially with respect to the rotor, the yokes 34 of this embodiment are oriented in a radial direction with respect to the rotor 30, i.e., the yokes 34 extend radially between the first set of permanent magnets 31 and the second set of permanent magnets 32. In addition, the number of yokes 34 is different from the number of said permanent magnets in each set such that at most two of the yokes (FIG. 14) or at most one of the yokes (FIG. 13) is aligned with respective permanent magnets at any one time.

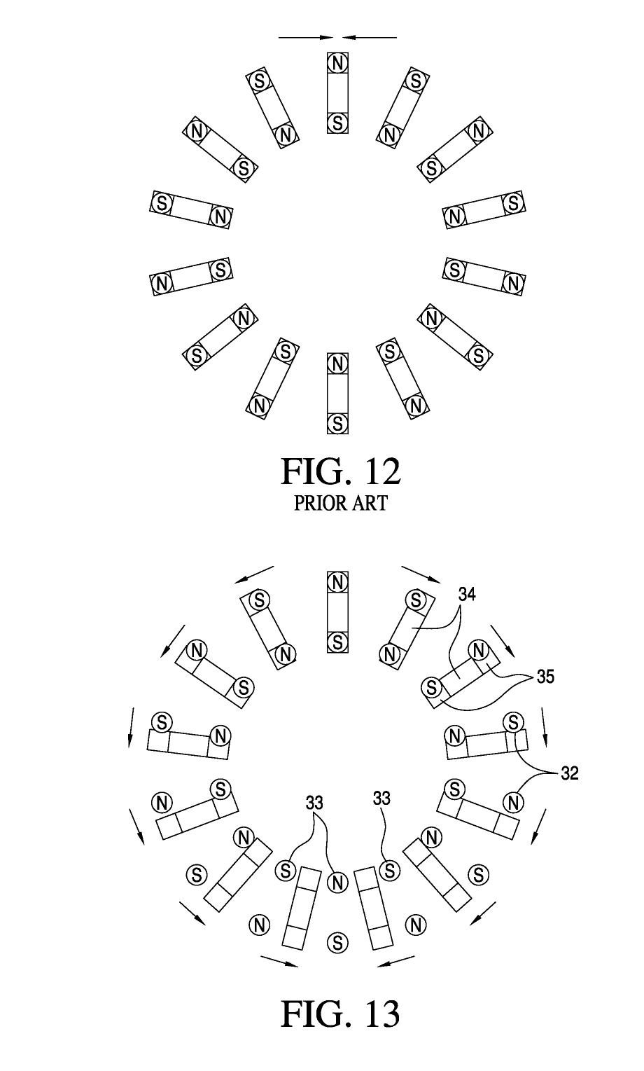

The reason for this arrangement can be understood by comparing the conventional arrangement of FIG. 12 with the arrangements of FIGS. 13, and 14. In the conventional arrangement illustrated in FIG. 12, a torque is generated which seeks to align the permanent magnets of the rotor with the stator poles. This cogging torque causes fluctuation or ripples in the torque or voltage output of the electrical machine, resulting in power losses and/or uneven operation. In order to eliminate this torque, the poles are shifted relative to the rotor magnets so that the sum of the cogging torques adds to zero around the circumference of the rotor. This is achieved by reducing the number of yokes 34, and therefore the number of poles 35, relative to the number of permanent rotor magnets 31,32 in each set so that the spacing between the poles is different than the spacing between the rotor magnets, as illustrated in FIGS. 13 and 14.

The arrangement of FIG. 14 is similar to previously proposed arrangements, such as the one described in U.S. Pat. No. 6,552,460, in that the numbers of yokes and magnets are exclusively even or exclusively odd, but 14 differs from that of U.S. Pat. No. 6,552,460 in it use of radially-aligned, “U”-shaped yokes. On the other hand, the preferred embodiment shown in FIG. 13 differs from the of U.S. Pat. No. 6,552,460 not with respect to the alignment and structure of the yokes, but also in that, the yokes and permanent magnets are uniquely arranged in an odd/even arrangement. For example, as shown in FIG. 13, there are 14 sets of permanent magnets and 13 stator yokes, resulting in reduced cogging while minimizing the resulting loss of torque due to the rejection in the number of yokes, and in addition achieves a perfect cancellation of the cogging torques.

FIG. 15 shows a practical implementation of the cogging reduction arrangement of the sixth preferred embodiment schematically illustrated in FIGS. 13 and 14. As shown in FIG. 15, the rotor 45 includes a plate 46 and a plurality of permanent magnets 47,48 arranged in two concentric rings around the circumference of the plate 46, the permanent magnets in the respective rings being radially aligned. The stator 49 includes plates 50 on which are mounted high permeability cores or yokes 51 and coils 52 at positions corresponding to those shown in FIG. 13. Plates 46 and/or 50 of the rotor and stator may be made of machined aluminum rather than a cast metal to reduce weight and cost, although use of cast metal, plastics, or ceramics is also within the scope of the invention. As illustrated, yokes 51 are mounted to the plates 50 by brackets 44 that preferably also provide a heat sink function, although adhesives or other mounting means may also be used to secure the yokes 51 to the stator plates 50 without departing from the scope of the invention.

It will therefore be appreciated by those skilled in the art that the arrangement illustrated in FIG. 13 may be implemented in numerous different ways, and that the specific structure illustrated in FIG. 15 is not intended to limit the ways in which the arrangement of FIG. 13 may be implemented within the scope of the invention. For example, the arrangement of FIG. 13 may be implemented with stator yokes that are situated on only one side of the rotor, rather than on both sides as illustrated in FIG. 13. In addition, it will be appreciated that the numbers and arrangement of magnets and yokes in FIG. 13 may also be varied without departing from the scope of the invention.

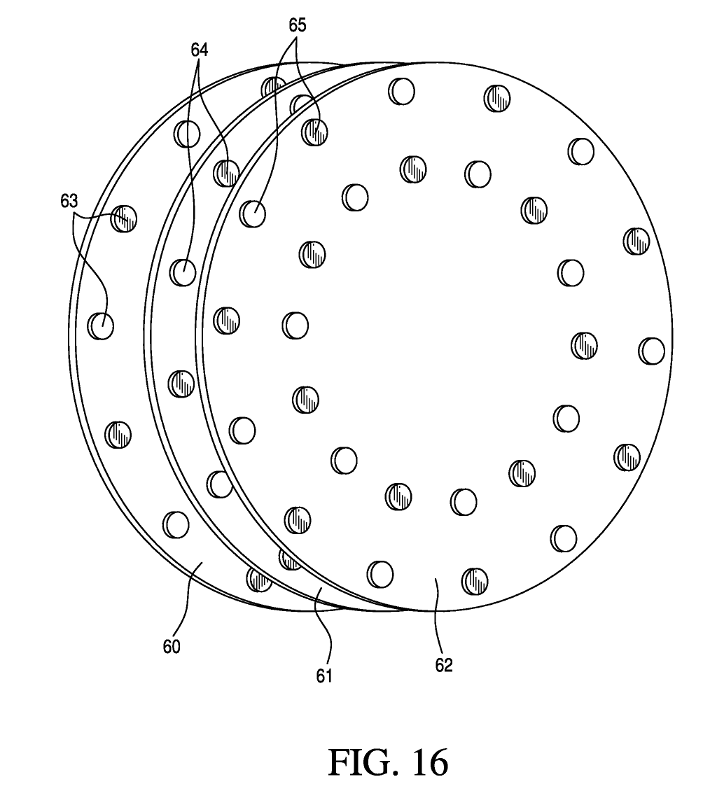

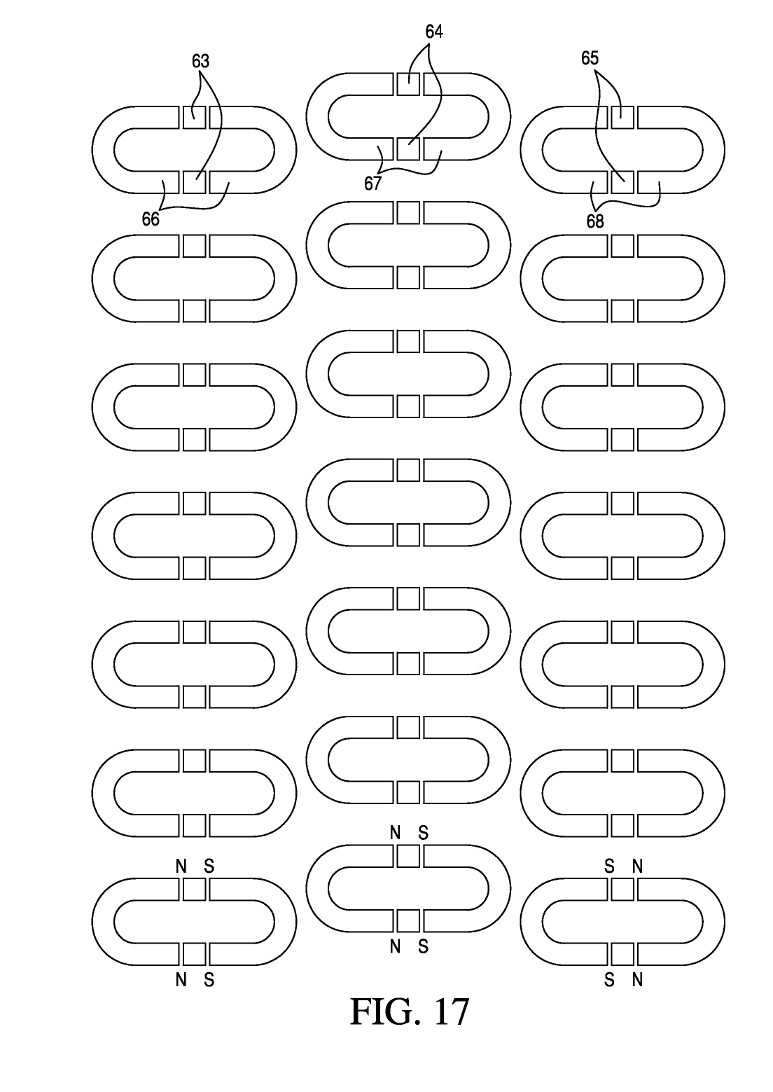

FIGS. 16 and 17 illustrate a variation of the preferred embodiment of FIGS. 13-15, which is adapted for three phase operation. In this embodiment, three rotor plates 60,61,62 having respective permanent magnets 63,64,65 are arranged in parallel, as illustrated in FIG. 16, and positioned with respect to three sets of yokes 66,67,68 in the manner illustrated in FIG. 17. In this variation, the magnets of the respective plates are shifted relative to each other to reduce cogging, with the magnets 63 of plate 60 being shifted by 120° relative to the magnets 64 of plate 61 and 240° relative to the magnets 65 of plate 62. Those skilled in the art will appreciate that the number of phases could be increased arbitrarily by adjusting the phase shift to be 360° divided by the number of phases.

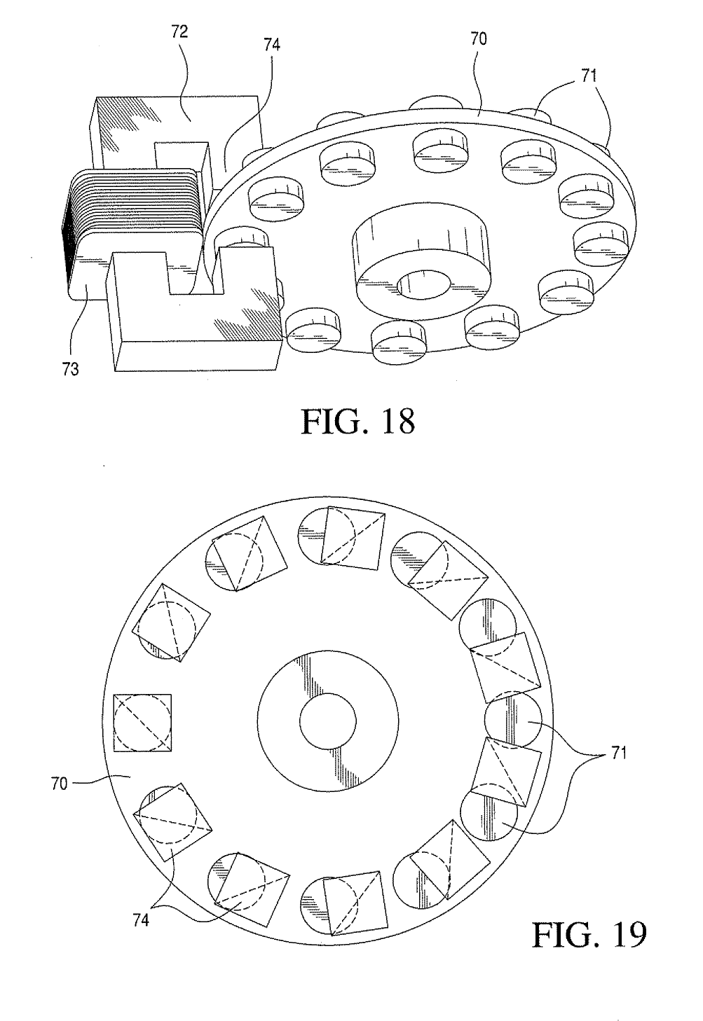

FIGS. 18-19 show an electrical machine constructed in accordance with the principles of a seventh preferred embodiment of the invention. In the electrical machine of this embodiment, the stator 70 again includes a plurality of magnets 71, which may be arranged in a manner similar to those of the first preferred embodiment described above. However, unlike the first preferred embodiment, the electrical machine of this embodiment includes “C”-shaped rather than “U”-shaped stator cores or yokes 72 and corresponding coils 73 arranged around a periphery of the rotor such that ends of the cores form poles 74 that face opposite sides of the rotor to permit the permanent magnets to pass therebetween Like the “U”-shaped cores described above, the “C”-shaped cores may includes linear sections, as illustrated, or may be rounded, and in addition may be made of any suitable high-permeability material such as stacked silicon laminations.

The arrangement shown in FIGS. 18 and 19 may be structurally similar to that disclosed in U.S. Pat. No. 6,552,460, but differs in at least one important respect. The difference is that the arrangement shown in FIGS. 18 and 19 uses an odd/even numerical relationship between the rotor magnets 71 and the “C”-shaped stator cores 73. In particular, FIG. 19 shows eleven cores 73 and twelve magnets 71, although it is to be understood that the numbers of cores and magnets is not to be limited to any absolute number, so long as the ratio between cores and magnets is an odd/even ratio to prevent cogging. By utilizing an odd/even ratio, the electrical machine can be arranged such that only one magnet faces one core at any one time, rather than every third magnet as in U.S. Pat. No. 6,552,460.

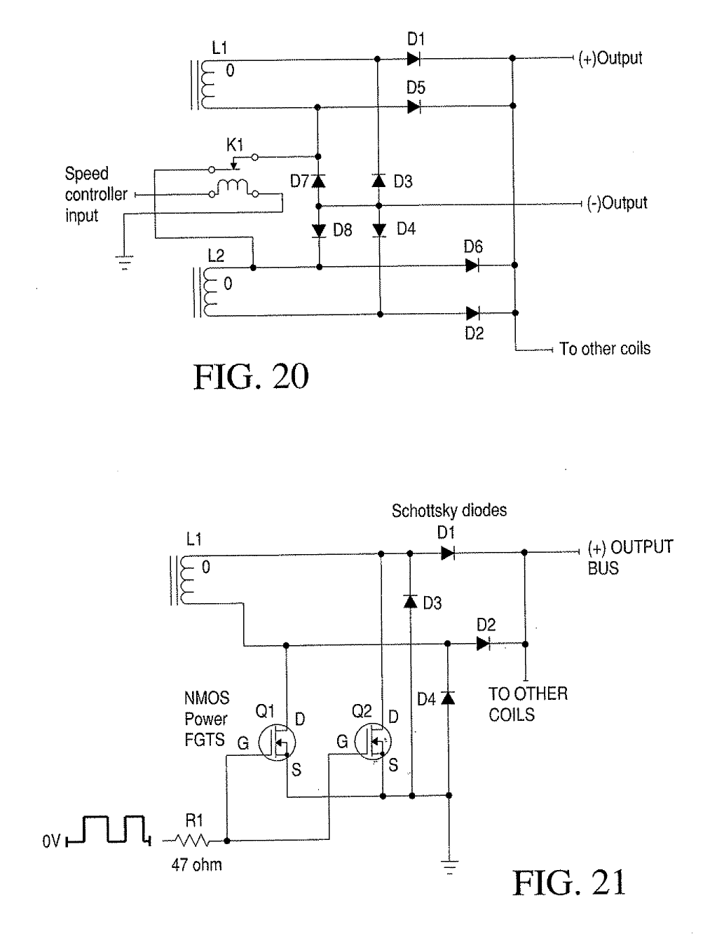

FIG. 20 shows a voltage reduction circuit that may be used with the electric machine structures illustrated in FIGS. 1-19, as well as with other electric machines that require voltage limitation, such as those used in wind power generation. The voltage reduction circuit includes stator coils L1,L2, diodes D1-D8 connected to coils L1,L2, and a switch, such as relay K1, controlled by an input from a speed controller or sensor to reduce the voltage at high speeds in order to avoid saturation by switching from a series to parallel connection and thereby reducing the voltage output by approximately a factor of two. At low speeds, relay K1 is closed to connect the ends of coils L1 and L2 together and form a series connection having a relatively high voltage and impedance (low current) output. In this state, diodes D5,D6,D7, and D8 are not active. At high speeds, relay K1 is opened to produce a lower voltage and impedance, and diodes D1 to D8 are all active.

FIG. 21, on the other hand, shows a voltage boost circuit that may be used to increase the output of the electrical machine when operated as a generator at low speeds. The boost circuit includes a pair of NMOS transistors Q1 and Q2 connected in parallel with rectified diodes D1,D2 and voltage limiting shunt diodes D3, D4, the transistors being controlled by a controller input through resistor R1 to boost the output from coil L1 through Schottsky rectifier diodes D1,D2 whenever the speed of electric machine is determined to be below a threshold speed. The “boost” is achieved by temporarily shorting the ends of coil L1, which has the effect of causing increases or decreases in the flux through the magnetic core of coil L1, i.e., through the stator yokes, the increases or decreases in flux in turn causing additional voltages to be induced in the coil, which are then rectified by diodes D1-D4 to obtain an increased output voltage.

In the embodiment shown in FIG. 21, gates or control electrodes G of the respective transistors are connected to receive a square wave or pulse control input though resistor R1 whenever the speed of the rotor is below a threshold, while the source electrodes S are connected to ground and drains D are connected to respective ends of the coil L1 and to the inputs of Schottsky diodes D1,D2, which serve as a rectifier and in turn are connected to an output bus. The duty cycle of the control input may be varied depending on the speed of the rotor, with a pulse width of 2 msec and spacing of 1 msec by way of example and not limitation. Transistors Q1 and Q2 of the preferred boost circuit may be in the form of negative-channel metal oxide semiconductor (NMOS) floating gate transistors (FGTs), although other types of semiconductor device or transistor, including other field-effect type transistors, may be substituted.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

I claim:

1. A high efficiency magnetic core electrical machine, comprising:
a disc-shaped rotor including a non-magnetic plate and a plurality of permanent rotor magnets, said rotor magnets being arranged in a first circle around said rotor and exposed at both principal surfaces of said plate to face stator poles; and
a stator including a plurality of “U” shaped yokes, ends of each of said yokes being surrounded by respective stator coils and forming two said stator poles, wherein:
said yokes extend in a circumferential direction with respect to said rotor such that said poles of each yoke are spaced tangentially and aligned with two said rotor magnets, and
said yokes are staggered such that a first pole of a first yoke on a first side of said rotor faces a first pole of a second yoke on a second side of said rotor, a second pole of said first yoke faces a first pole of a third yoke on the second side of said rotor, said third yoke being different from said second yoke, a first pole of a fourth yoke on said first side of said rotor faces the second pole of the third yoke, and so forth for respective poles around the circumference of the rotor, with said permanent magnets being arranged to pass between said facing poles.

2. A high efficiency magnetic core electrical machine as claimed in claim 1, wherein a distance between the two poles of each yoke equals a distance between said magnets.

3. A high efficiency magnetic core electrical machines as claimed in claim 1, further comprising a second set of permanent magnets extending around said rotor in a second circle that is radially inward of said first circle, and a corresponding second set of staggered magnetic yokes.

4. A high efficiency magnetic core electrical machine as claimed in claim 3, wherein a number of yokes in said second set of yokes is less than a number of yokes in said first set of yokes.

5. A high efficiency magnetic core electrical machine as claimed in claim 3, further comprising a pair of shield plates situated between said rotor and said yokes on each side of said rotor, said shield plates being made of a magnetic shielding material and having a plurality of openings,
wherein said shield plates are movable between a position in which said openings are aligned with said yokes and a position in which said openings are not aligned with said poles, wherein in said first position a maximum amount of magnetic flux passes between said permanent rotor magnets and said poles, and wherein as said plates are moved to said second position, an amount of flux passing between said rotor magnets and said poles decreases to thereby reduce a torque or electrical output of said electrical machine.

6. A high efficiency electrical machine as claimed in claim 5, further comprising a speed sensor and an actuator for moving said shield plates,
wherein said actuator causes said shield plates to move away from said first position when a speed of said rotor detected by said speed sensor exceeds a predetermined speed.

7. A high efficiency electrical machine as claimed in claim 1, further comprising an actuator for increasing and decreasing a distance between said yokes and said rotor to thereby increase or decrease a torque or electrical output of said electrical machine.

8. A high efficiency electrical machine as claimed in claim 7, further comprising a speed sensor, wherein said actuator causes said yokes to be moved away from said rotor when a speed of said rotor detected by said speed sensor exceeds a predetermined speed.

9. A high efficiency electrical machine as claimed in claim 1, further comprising a voltage reduction circuit connected between said stator coils in parallel with a diode bridge circuit, said voltage reduction circuit including a switch controlled by an input from a rotor speed detection circuit, said switch being arranged to close said voltage reduction circuit and thereby reduce a voltage output of said electrical machine by connecting said coils in parallel rather than series when a detected speed exceeds a predetermined threshold.

10. A high efficiency electrical machine as claimed in claim 1, further comprising a boost circuit having a control input connected to a pulse signal source whose output depends on rotor speed, said boost circuit being connected to respective ends of a stator coil to boost an output of said circuit by briefly shorting ends of said coil in order to vary magnetic flux in the stator yoke and thereby induce additional voltages in said stator coil in response to detection of a low rotor speed.

11. A high efficiency electrical machine as claimed in claim 1, wherein said rotor is a machined aluminum plate.

12. A high efficiency electrical machine as claimed in claim 1, wherein said rotor is connected to stator plates by brackets, said brackets made of a heat conductive material to serve as heat sinks for said yokes.

13. A high efficiency magnetic core electrical machine, comprising:
a disc-shaped rotor including a non-magnetic plate and two sets of permanent magnets, said two sets of permanent magnets each extending around a circumference of said rotor, said second set being radially aligned with said first set and including a same number of magnets as said first set; and
a stator including a plurality of “U” shaped yokes having stator coils wound around respective legs of the yokes, ends of said yokes forming poles that face said rotor, wherein:
said yokes extend between said two sets of permanent magnets such that poles of each yoke are spaced radially, and
a number of said yokes is different from a number of said permanent magnets in each set such that said at most one of said yokes is aligned with respective permanent magnets at any one time.

14. A high efficiency magnetic core electrical machine as claimed in claim 13, wherein a number of magnets in each set is even and a number of said yokes is odd.

15. A high efficiency magnetic core electrical machine as claimed in claim 13, wherein a number of magnets in each set is odd and a number of said yokes is even.

16. A high efficiency magnetic core electrical machine as claimed in claim 13, wherein said plurality of magnets are exposed at both principal surfaces of said plate to face poles of a stator; and further comprising a second set of yokes arranged on a second side of said rotor at positions corresponding to positions of said first set of yokes.

17. A high efficiency magnetic core electrical machined as claimed in claim 13, further comprising as second set of said yokes on an opposite side of said rotor, rotor magnets passing between facing poles of the two sets of yokes.

18. A high efficiency magnetic core electrical machine as claimed in claim 13, further comprising a shield plate situated between said rotor and said yokes, said shield plate having a plurality of openings,
wherein said shield plate is movable between a position in which said openings are aligned with said yokes and a position in which said openings are not aligned with said poles, wherein in said first position a maximum amount of magnetic flux passes between said permanent rotor magnets and said poles, and wherein as said plate is moved to said second position, an amount of flux passing between said rotor magnets and said poles decreases to thereby reduce a torque or electrical output of said electrical machine.

19. A high efficiency electrical machine as claimed in claim 18, further comprising a speed sensor and an actuator for moving said shield plate,
wherein said actuator causes said shield plates to move away from said first position when a speed of said rotor detected by said speed sensor exceeds a predetermined speed.

20. A high efficiency electrical machine as claimed in claim 13, further comprising an actuator for increasing and decreasing a distance between said yokes and said rotor to thereby increase or decrease a torque or electrical output of said electrical machine.

21. A high efficiency electrical machine as claimed in claim 20, further comprising a speed sensor, wherein said actuator causes said yokes to be moved away from said rotor when a speed of said rotor detected by said speed sensor exceeds a predetermined speed.

22. A high efficiency electrical machine as claimed in claim 13, further comprising a voltage reduction circuit connected between said stator coils in parallel with a diode bridge circuit, said voltage reduction circuit including a switch controlled by an input from a rotor speed detection circuit, said switch being arranged to close said voltage reduction circuit and thereby reduce a voltage output of said electrical machine by connecting said coils in parallel rather than series when a detected speed exceeds a predetermined threshold.

23. A high efficiency electrical machine as claimed in claim 13, further comprising a boost circuit having a control input connected to a pulse signal source whose output depends on rotor speed, said boost circuit being connected to respective ends of a stator coil to boost an output of said circuit by briefly shorting ends of said coil in order to vary magnetic flux in the stator yoke and thereby induce additional voltages in said stator coil in response to detection of a low rotor speed.

24. A high efficiency electrical machine as claimed in claim 13, wherein said rotor is a machined aluminum plate.

25. A high efficiency electrical machine as claimed in claim 13, wherein said rotor is connected to stator plates by brackets, said brackets made of a heat conductive material to serve as heat sinks for said yokes.

26. A high efficiency electrical machine as claimed in claim 13, wherein a number of said stator plates is three and permanent magnets is respective plates are shifted by 120° between respective plates to provide three-phase operation of the motor without cogging.

27. A high efficiency magnetic core electrical machine, comprising:
a disc-shaped rotor including a non-magnetic plate and a plurality of permanent magnets, said permanent magnets each extending around a circumference of said rotor; and
a stator including a plurality of “U” shaped yokes, principal planes of said yokes being coplanar and parallel with said non-magnetic plate of said rotor, and ends of each of said yokes forming two poles, wherein:
a first pole of said first yoke faces a first pole of a second yoke with a gap therebetween; a second pole of said first yoke faces a first pole of a third yoke different from said second yoke; a second pole of said second yoke faces a first pole of a fourth yoke with a gap therebetween; and a second pole of the fourth yoke faces a first pole of a fifth yoke with a gap therebetween,
said yokes thereby form a continuous magnetic flux path extending in a circle such that a second pole of said second yoke faces a second pole of an nth yoke, wherein n is a total number of said yokes, and
said gaps are aligned with said permanent magnets of said rotor.

28. A high efficiency magnetic core electrical machine as claimed in claim 26, wherein said gaps are filled with a non-magnetic material.

29. An output control mechanism for an electrical machine including a planar rotor having a plurality of permanent magnets situated within the rotor and a plurality of stator yokes arranged to face said plurality of permanent magnets, said output control mechanism comprising:
at least one output control plate situated between said permanent magnets and said rotor, said output control plate being made of a magnetic shielding material and having a plurality of openings,
wherein said shield plate is movable between a position in which said openings are aligned with said yokes and a position in which said openings are not aligned with said poles, wherein in said first position a maximum amount of magnetic flux passes between said permanent rotor magnets and said poles, and wherein as said output control plate is moved to said second position, an amount of flux passing between said rotor magnets and said poles decreases to thereby reduce a torque or electrical output of said electrical machine.

30. An output control mechanism for an electrical machine as claimed in claim 29, further comprising a speed sensor and an actuator for moving said shield plate,
wherein said actuator causes said shield plate to move away from said first position when a speed of said rotor detected by said speed sensor exceeds a predetermined speed.

31. An output control mechanism for an electrical machine including a planar rotor having a plurality of permanent magnets situated within the rotor and a plurality of stator yokes arranged to face said plurality of permanent magnets, said output control mechanism comprising sensor means for detecting an operating parameter of said electrical machine and outputting a signal indicative of said operating parameter, and actuator means for increasing and decreasing a distance between said yokes and said rotor to thereby increase or decrease a torque or electrical output of said electrical machine in response to said signal.

32. A high efficiency electrical machine as claimed in claim 30, wherein said sensor means is a motor speed sensor, and wherein said actuator causes said yokes to be moved away from said rotor when a speed of said rotor detected by said speed sensor exceeds a predetermined speed.

33. A voltage reduction circuit for an electrical machine that includes a rotor having a plurality of permanent magnets situated within the rotor and a plurality of stator yokes arranged to face said plurality of permanent magnets, said stator yokes being surrounded by stator coils, wherein said voltage reduction circuit is connected between said stator coils in parallel with a diode bridge circuit and includes a switch controlled by an input from a rotor speed detection circuit, said switch being arranged to close said voltage reduction circuit and thereby reduce a voltage output of said electrical machine by connecting said coils in parallel rather than series when a detected speed exceeds a predetermined threshold.

34. A boost circuit for an electrical machine including a rotor having a plurality of permanent magnets situated within the rotor; a plurality of stator yokes arranged to face said plurality of permanent magnets; and a plurality of stator coils wound around said stator yokes; wherein:
said boost circuit has a control input connected to a pulse signal source whose output depends on rotor speed, and
said boost circuit is connected to respective ends of a stator coil to boost an output of said circuit by briefly shorting ends of said coil in order to vary magnetic flux in the stator yoke and thereby induce additional voltages in said stator coil in response to detection of a low rotor speed.

35. A boost circuit as claimed in claim 34, wherein said boost circuit includes a pair of transistors connected to respective ends of a respective stator coil, said transistors having control electrodes connected to said pulse signal source, wherein voltages induced upon shorting said ends of said coils are output through a rectifier circuit connected to said ends of said coils.

36. A high efficiency magnetic core electrical machine, comprising:
a disc-shaped rotor including a non-magnetic plate and a plurality of permanent magnets, said permanent magnets each extending around a circumference of said rotor; and
a stator including a plurality of “C” shaped yokes extending around a periphery of the rotor such that poles formed by ends of the yokes face opposite sides of the rotor, wherein said permanent magnets pass between said poles,
wherein said yokes and said permanent magnets have an odd/even numerical relationship to prevent cogging such that if a number of said yokes is even, a number of said magnets is odd, and such that if a number of said magnets is even, a number of said yokes is odd.
